(19) United States
(12) Patent Application Publication
(10) Pub. No.: US 2002/0140554 A1
(43) Pub. Date: Oct. 3, 2002

(54) Method and apparatus for improving the safety of stabbing operations involving the movement and alignment of oil field casing

(76) Inventors: Donald E. Mosing, Lafayette, LA (US); David L. Sipos, Youngsville, LA (US); Jeremy R. Angelle, Lafayette, LA (US)

Correspondence Address: William E. Johnson, Jr., The Matthews Firm, Suite 1800, 1900 West Loop South, Houston, TX, 77027, US

(21) Appl. No.: 09/822,618

(22) Filed: Mar. 30, 2001

(51) Int. Cl. G08B 21/00; G08B 1/00

(52) U.S. Cl. 340/540; 340/531

(57) ABSTRACT

A portable RF transmitter is carried aloft by a stabber in an oilfield derrick to observe a casing stabbing operation, and to determine whether the upper joint of casing, suspended by a crown block and an elevator, has been successfully stabbed into the lower joint of casing. Once that determination has made that the stabbing was successful, the stabber activates the RF transmitter to send a signal to the driller stationed at the driller's console on or near the drilling rig floor. The RF signal initiates an indication to the driller, usually one or more lights on the driller's console, that the stabbing process was successful, and that it is now safe for the driller to raise the elevator away from the upper joint of casing. Alternatively, the transmitted signals may be electrical, electronic, hydraulic, pneumatic, optical, infra-red, or microwave. The indication to the driller that the stabbing operation was successful may be visual, audible, or tactile in nature.

### FIELD OF THE INVENTION

This invention relates to apparatus for engaging and for positioning large diameter well casing, and more particularly, to an apparatus which can be mounted in a derrick extending upwardly over a drilling rig platform, and then can be controlled to engage a section of oil or gas well casing hanging from a crown block in the derrick, and can then be further used to steer and align the section of well casing so that the threads at one end thereof are prevented from cross threading with the threads of a casing section therebelow at the time when the two casing sections are threaded together. A stabber carrying a portable, button-controlled radio transmitter, standing aloft in the derrick, usually on the stabber board, causes a transmitted RF signal to activate a radio receiver in the driller's console and thus a light bank in the console, thereby indicating to the driller that the elevators can be raised or lowered.

### BRIEF DESCRIPTION OF THE PRIOR ART

Various types of apparatus have been provided to assist in the manual alignment and interconnection of sections of elongated drill pipe and other tubular stock used in the drilling and completion of oil and gas wells. Most of these devices employ mechanical advantage, and in many cases hydraulics, to cause a pair of gripping elements or tongs to surround and engage the tubular stock, and then to use leverage or hydraulics to swing the tubular stock to a precise position within a derrick and generally immediately over the well head at which a second section of the tubular stock is located. The manipulation described is used to position the upper section of tubular stock over the one suspended in the well bore at the well head so that the two ends thereof can be threaded together and the string of tubular members projecting down into the well bore extended by such threaded addition.

A number of patents have also been proposed which handle drill pipe and drill collars from a location in the derrick by engaging sections or joints of such drill pipe or drill collar and swinging these joints to a racking location where the drill pipe is stored pending use of the drill pipe. In general, the problems of handling drill pipe differ significantly from the problems which are encountered when very large diameter casing sections are to be engaged and moved from one location to another, particularly when the objective is to align a joint of the drill pipe with the upper end of a joint of drill pipe suspended at the rotary table and projecting down into the well bore. One reason for this difference in the problems encountered is that the drill pipe is usually of much smaller diameter than large diameter casing, and consequently may have as much as 200 pounds per foot weight differential which is very significant, and, perhaps most importantly, has very coarse threads which are difficult to misalign as the suspended upper joint of the drill pipe is brought into end-to-end abutting relationship with the suspended pipe joint for threaded interconnection of the two.

Sections of casing, on the other hand, carry relatively fine threads, and it is easy to cross thread the threaded female or pin end of one casing section with the box end of another section. Such cross threading will result from very slight misalignment of the axis of the casing section being lowered in the derrick from the crown block to effect such threaded engagement, with the axis of the uppermost section of casing suspended in the well bore by the engagement of slips at the well head.

U.S. Pat. No. 4,077,025 issued in 1978 to Callegari et al discloses an apparatus which can be mounted in an oil well derrick in order to manipulate and maneuver joints or lengths of drill pipe into or out of one or more fingerboards which are mounted above the apparatus in the derrick. The apparatus includes a pipe manipulating arm which can move in two planes of movement, but cannot be rotated up or down on the derrick to remove the drill pipe handling apparatus as an obstruction within the enclosed area inside of the derrick. A pipe manipulating arm carries a pipe gripping hand at one end thereof, and the pipe manipulating arm is telescoped to facilitate extension of the length of the arm when desired. Further, the gripping hand is rotatably attached to one end of the arm so that it can be oriented at various angles with respect to the drill pipe. The system is hydraulically actuated. The telescoping arm extends and retracts along a single invariant line.

This apparatus is useful, as it is described in this patent, solely for the racking of drill pipe of relatively smaller diameter, and would not be useful for stabbing and manipulating large diameter casing. The basic arm which projects inwardly from the side of the derrick must project at a right angle to the derrick and there is no capability in the Callegari apparatus of extending this arm at a selected angle with respect to the plane of the side of the derrick.

Swoboda al U.S. Pat. No. 3,840,120 is also a racking arm which is intended to be mounted on the floor of a drilling rig and used for racking drill pipe, drill collars and riser pipe. It is not adapted, nor can it be used effectively, for stabbing casing from a point in the derrick, particularly large diameter casing. The apparatus includes a racking arm which has a telescoping boom which is supported at one of its ends and has a free cantilevered end opposite the supported end. A pipe gripping head is secured to the cantilevered end of the boom for clamping about drill pipe sections and drill collars. The manner in which the cooperating jaws of the Swoboda apparatus are hingedly interconnected requires the jaws to have a significant movement space in order to open and close.

The Swoboda apparatus is very heavy and very complicated and functions primarily as a device which must be supported on the rig floor and cannot be mounted in the derrick. Moreover, the jaws which are used in the Swoboda device for engaging the drill pipe are limited in size to drill pipe which probably will not exceed about eight inches in maximum diameter.

Finally, the Swoboda racking arm cannot be operated from a remote, selectively variable location so as to control the movement of drill pipe carried at one end of the arm while the operator of the apparatus is moving around from one location to another to sight in the drill pipe during its movement.

U.S. Pat. No. 2,615,681 to True describes an apparatus for handling drill pipe so as to facilitate the coupling and uncoupling of sections of drill pipe being lowered into, or removed from, a well bore. The apparatus includes a carriage mounted on a trackway which is positioned on the floor of a derrick. An extensible and retractable arm is mounted on a housing which in turn is mounted on the carriage. The arm carries on a free end, a hook or fork adapted to grasp and release a vertical stand of pipe. Power devices are provided for moving the carriage along the track, and for actuating the extensible and retractable arm and the hook which is carried on the free end of the arm. The apparatus is complicated in its construction, and is incapable of being mounted without difficulty anywhere except on the rig floor. Moreover, the construction of the drill pipe handling apparatus is such that it is not well adapted for engaging and positioning large casing sections having diameters in excess of 12 inches. The True apparatus makes no provision for yawing or pivoting the boom about a vertical axis to achieve side-to-side motion.

U.S. Pat. No. 2,450,934 to Calhoun describes an apparatus for hydraulically actuating tongs used for making and breaking joints of drill pipe as the pipe is moved into and out of a well bore. The tongs employed are mounted on a post extending upwardly from a platform which can be positioned on the derrick floor. A detachable control head is utilized on the tong, and is operable by means of hydraulic power facilitating operation of the tong from a remote location by an operator. A hydraulically actuated work positioning and orienting arm is mounted on the supporting post, and its movement is controlled from a remote location. A number of complicated mechanical linkages are required for operation of the Calhoun apparatus, and the nature of its construction is such that it must be supported on the rig floor, rather than mounted in the derrick.

Willis U.S. Pat. No. 4,403,897 is a self-centering clamp for downhole tubulars which includes jaw members which can be caused to move vertically relative to a drilling platform by means of a hydraulic cylinder, and can then be caused to move in a convergent fashion with respect to each other so as to clamp upon a pipe section and guide the pipe section downwardly for engagement with a second section of pipe. The jaws are hydraulically actuated. Because the Willis structure is intended to lift a tubular, such as a section of drill pipe, from a horizontal to a vertical position before lowering it for engagement with a lower section of drill pipe, the apparatus is more complicated than the apparatus which would be needed to position sections of drill pipe or casing suspended from the crown block of a derrick. The clamping jaws utilized do not, in themselves, allow for any spinning or rotative movement of the tubular member which is engaged by the clamps.

In Reed U.S. Pat. No. 3,467,262, a pipe stabbing apparatus is disclosed in which an extensible boom is utilized for extending and retracting a pair of pivotal jaws capable of holding and releasing joints of drill pipe. The extensible boom may be pivoted in a horizontal plane through a desired angle to enable the stabbing head which carries the jaws to reach the points where the drill pipe is needed. A hydraulic piston and cylinder assembly is connected to the extensible boom for pivoting it about a vertical axis in order to vary the angular position of the extensible boom on its foundation. The pipe stabbing head on the end of the boom carries a jaw which is mechanically actuated to open and close the jaw about a section of drill pipe. The jaw provided is inadequate in size, structural strength and mode of operation for gripping extremely large diameter tubulars, such as casing sections exceeding about ten inches in diameter, and no provision is made for the spinning or turning of the suspended casing or drill pipe section within the jaw once engagement is effected.

Podlesak U.S. Pat. No. 3,112,830, although not relating to oil field tubular goods in its application, does relate to a pole-handling device which includes an elongated extensible boom which is pivotally connected to a massive support structure. A hydraulic cylinder is provided for elevating and lowering the boom, and a pair of convergent and divergent jaws are carried on the free end of the boom. These jaws are clamped about the tubular by means of a hydraulic piston and cylinder arrangement which pivots the jaws about pivot points located near one end of the jaws. The jaws can also be made to undergo a yawing movement by means of a hydraulic piston and cylinder assembly. Due to the massive character of the support structure upon which the boom and associated hydraulics are carried, the Podlesak structure would be unsuitable for use in stabbing tubular goods suspended from the crown block of a derrick of the type used in the drilling and completion of oil and gas wells.

Guiers U.S. Pat. No. 3,514,822, discloses a transporter for manual slips used to engage and support a drill pipe section in a rotary table. The transporter apparatus includes a boom having a pipe gripping jaw at one end thereof which is mounted upon a supporting platform or table, which in turn is rested upon the rig floor. The boom is moved from a position offset from the drill pipe section to be engaged into a position where the jaws can grip the drill pipe. This pivotal motion of the boom is accomplished by a hydraulic piston and cylinder assembly which can be operated from a remote location at which a hydraulic control console is located.

Other stabbing devices for engaging and positioning tubular elements such as drill pipe and casing, during the making up of strings of drill pipe and casing are disclosed in U.S. Pat. Nos. 2,822,024; 2,820,783 and 3,467,262.

Graham et al U.S. Pat. No. 2,206,184 discloses which can be mounted in the derrick during an oil well drilling and completion operation to center and steady a casing section while it is aligned with, and joined to, a preceding section going into the well bore. The apparatus employed includes a guiding and restraining or steadying member which is used to partially engage the suspended casing section, and also includes a supporting carriage which is mounted in the derrick, and which permits the guiding and steadying member to be moved laterally from side-to-side of the derrick. The guiding and steadying member is merely a V-shaped supporting surface which can be moved in order to push a casing section contacted thereby. It is also possible to vary the angulation formed between the two members forming the V configuration in the guiding and steadying member in order to accommodate casing sections of varying sizes.

A similar device is shown in Guier U.S. Pat. No. 3,533,516. Here, however, the portion of the apparatus which is angulated to permit engagement with the tubular element being connected is carried on the end of, and formed integrally with, an elongated arm which is pivotable about a horizontal axis to cause the arm to be yawed or swiveled in a horizontal plane. The arm and the hydraulic piston and cylinder assembly used for imparting the yawing motion are mounted on an upright stand or standard, which in turn is supported on a base plate which can be rested on the rig floor or drilling platform.

A subterranean well pipe positioning apparatus is disclosed in Scaggs U.S. Pat. No. 4,274,777. In the Scaggs patent, an apparatus is disclosed for engaging and guiding suspended pipe section joints which hang from the crown block of a derrick. The apparatus includes an elongated boom which is mounted to the derrick through a rotary axle to permit pivotation upwardly and downwardly. A power cylinder is provided for rotating the apparatus about the horizontal rotary axle. A pair of guide jaws are pivotally attached to the outer end of the boom and are actuated by a cylinder which causes the jaws to open and close with respect to each other in order to engage a pipe to be selectively positioned.

A different approach to the engagement and selective guiding of a suspended casing section during section coupling operations is disclosed in Russe U.S. Pat. No. 4,295,527. In the Russe patent, the apparatus employed is first clamped or secured by a lower clamp assembly to the upper end of a lower casing section which protrudes slightly above the rig floor. Projecting upwardly, and offset from the axis of this casing section, is an upright member which extends substantially parallel to the axis of the lower casing section and a substantial distance above the upper end of the lower casing section. The upper end of the upright member carries an upper gripping assembly which includes a pair of pivotally mounted jaws which can be used to grip and engage the descending suspended casing section which is to be screwed into the lower casing section. The jaws are hydraulically actuated to clamp against the casing, but no provision is made to permit the casing to rotate on the swivel from which it is suspended. Moreover, it is necessary with the Russe structure to have a sufficient amount of the lower casing section extending upwardly from the rotary table to permit the lower clamp assembly to be clamped thereto.

Thus, there has been developed over the years a great variety of systems for stabbing oil field casing. With many of these systems, there is a “stabber” which climbs up on the derrick and observes the stabbing operating and who will signal to the driller when it is safe to lower or raise the elevator. There has long been a need for the driller and the stabber to communicate more effectively. As a major part of the communication process, it is essential that the stabber be able to make known to the driller exactly when it is safe to raise or lower the elevator. As used herein, the “driller” shall mean the operator on or near the drilling rig floor who monitors and controls at least the majority of the drilling, completion and casing of an oil or gas well, including, without being limited to, the movement of the crown block and elevators supported by the derrick. The “stabber” shall meant the person, sometimes located on the stabbing board, who observes the casing stabbing operation and who signals to the driller that the elevator can be safely lifted or raised.

This attempted communication has historically been accomplished by hand signals from the stabber who is stationed on a stabber board located high in the derrick, quite far above the rig floor and above the driller. This process requires the driller to keep his head tilted upward for long periods of time in order to observe the stabber and wait for his hand signal. Voice communication is impossible due to the distance and the ambient noise level. Hand signals are somewhat imprecise because of the difficulty of being able to discern the intent of the specific hand motions of the stabber. When the stabber is busy his hands are constantly moving in many directions and signals may be missed, or worse, misinterpreted.

The prior art has suggested, as exemplified by U.S. Pat. Nos. 5,049,020 and 5,062,756, that the casing stabbing operation can be controlled from a remote selectively variable location, through the use of a manually manipulatable wand or joy stick which can be carried in one hand as he moves about the drilling platform of the rig. While the systems shown in `.S. Pat. Nos. 5,049,020 and 5,062,756 have been commercially successful, they are nonetheless dependent upon using hand signals between the stabber and the operator of the crown block and elevators in terms of raising or lowering the casing section which is engaged by the casing stabbing apparatus, for example as suggested in Col. 18, lines 13-20 of U.S. Pat. No. 5,049,020.

### OBJECTS OF THE INVENTION

It is therefore the primary object of the present invention to provide new and improved methods and apparatus for improving communication between the stabber and the driller involved in casing stabbing operations.

It is another object of the present invention to provide new and improved methods and apparatus for communication between the stabber and driller which can be accomplished without necessarily involving the use of either hand signals or voice communications.

Additional objects and advantages of the invention will become apparent as the following detailed description of the invention is read in conjunction with the accompanying drawings which illustrate a preferred embodiment of the invention.

### BRIEF DESCRIPTION OF THE DRAWINGS

FIG. 1 is a perspective view, with parts broken away, showing a drilling rig platform with a derrick extending thereover, and a casing stabbing apparatus mounted in the derrick and in use for engaging a section of casing suspended from a crown block at the top of the derrick.

FIG. 2 is an isometric, schematic view of a driller's console, according to the present invention, located on the drilling rig floor illustrated in FIG. 1, and also including a transmitter for use by the stabber (not illustrated) from the stabbing board situated aloft in the derrick illustrated in FIG. 1.

### DETAILED DESCRIPTION OF A PREFERRED EMBODIMENT OF THE INVENTION

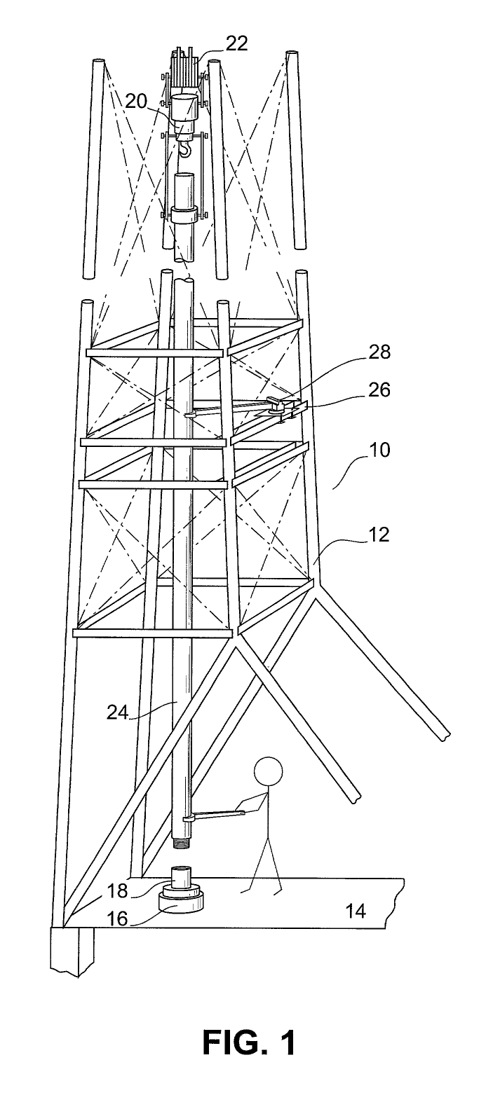

Referring initially to FIG. 1 of the drawings, shown therein is an oil well drilling rig 10 which, in that portion of the rig illustrated, includes a vertically extending derrick 12 and a rig floor or drilling platform 14. A rotary table 16 positioned on the rig floor 14 is used for supporting, by means of suitable slips (not shown), an elongated section of casing 18 which projects downwardly from the rig floor into the well bore.

In running a string of casing into a well, it is necessary to serially interconnect sections of the casing at a point of joinder at the rig floor, and to this end each succeeding section of casing to be attached to the section therebelow is suspended from a swivel 20 which is raised and lowered from a crown block 22 mounted at the top of the derrick 12. In FIG. 1, such a casing section 24 which is about to be threadedly connected to the section 18 therebelow is illustrated as suspended from the crown block 22. As is typical of the construction of a derrick, the derrick includes cross members 26 which are I-beams.

A principal purpose and usage of the present invention is to stab or engage a median portion of a suspended section of large diameter casing with the casing stabbing apparatus of the invention. The stabbing apparatus is thereafter used to swing or move the casing section so as to more precisely align the end of the suspended casing section over the section of casing hung by slips in the rotary table, thereby permitting the casing sections to be threadedly engaged without cross threading. The casing stabbing apparatus of the present invention which is provided for this purpose is denominated generally by reference numeral 28. As illustrated in FIG. 1, the casing stabbing apparatus can be mounted in the derrick 12 by bolting the apparatus to one of the I-beam cross members 26.

The present invention does not depend at all upon the particular casing stabber apparatus used. If desired, the casing stabber used can conform, for example, with the apparatus described in any of U.S. Pat. Nos. 5,062,756; 5,049,020; 5,609,457 or 4,652,195. It is only after the casing has been successfully stabbed into the casing immediately therebelow, that the stabber signals to the driller that the elevator can be safely raised.

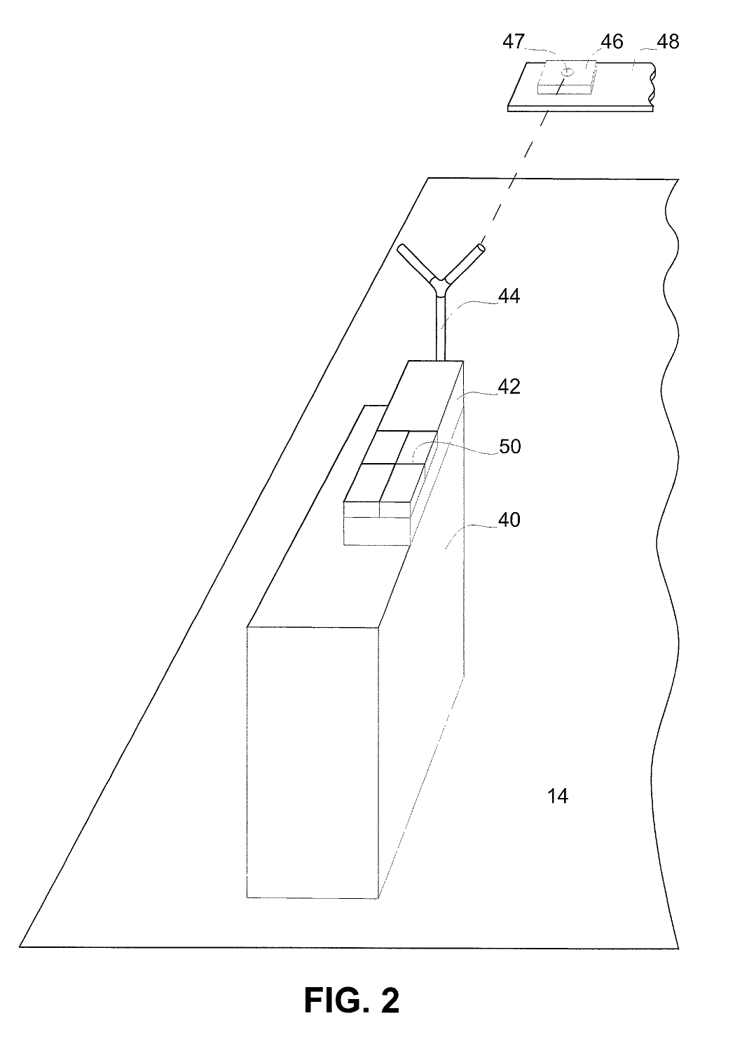

FIG. 2 illustrates a driller's console 40 located on the drilling rig floor 14 illustrated in FIG. 1. The console 40, from which the driller (sometimes referred to as an operator) controls most of the operations involved in drilling, casing and completing an oil or gas well. The driller, from the driller's console 40, typically controls the traveling block and the elevators used to lower or raise the section of casing 24. Mounted on the console 40 is a radio receiver 42 for receiving at its antenna 44 signals from a radio transmitter 46 carried by the stabber (not illustrated) standing on the stabber board 48 located up in the derrick 12 above the floor 14. A button 47 on the surface of transmitter 46, when depressed, transmits an RF signal to the receiver 42, which in turn activates a light bank 50. The light bank 50 comprises one or more lights which indicate to the driller that the elevators may be raised or lowered, as the case may be.

In the preferred embodiment, the transmitter 46 is battery powered, with button activation, and the receiver 42 is also battery operated, with one or more bright LED lamps as the signal medium. Very low voltage (3.5 volts) is utilized so the devices will be intrinsically safe. Alternatively one can hard wire the components together or, to use optical signals, for example, a laser signal, micro wave signals or, even infra-red signals. For those signals which are essentially line-of-sight, requiring the transmitter to be aligned with the receiver, this can be better accomplished by firmly attaching the transmitter (following alignment) to the stabber board or to the frame of the derrick, rather than remaining in the hands of the stabber. Moreover, the lamp could be replaced with a horn or siren or, a mechanically operated flag might be waved. In the case of a mechanical device, the signal transmission apparatus could be; a cable, a hydraulic or a pneumatic system. It could even be considered that, the receiving device could be tactile in nature, i.e. a vibrator to be worn by the driller. One advantage of a audible or tactile system is that, the driller would not be required to concentrate on a lamp. The primary point is: To provide a clear, consistent signal—visual, tactile or audible in nature—to the driller at the demand of the stabber.

Thus, there has been illustrated and described herein new and improved methods and apparatus which improve communication between the driller and the stabber. The system consists of two members; a small, hand-held, remote sending unit that is carried aloft by the stabber and a receiver with an integral signal lamp that is positioned on the driller's console. When the stabber is ready for the driller to lift or lower the elevator, the stabber presses the button on the remote sending unit and the lamp lights up on the drillers console. Thus, the stabbers intentions are consistently clear. The system avoids confusion and the attendant errors, accidents and lost time, which would be the likely outcome.

1. A method for improving the communication between the driller and the stabber in a casing stabbing operation carried on within an oilfield derrick, comprising:
determining at a first location within or near said derrick that a first joint of casing has been successfully stabbed into a second joint of casing;
transmitting a signal from the stabber at the first location to the driller at a second location at or near the rig floor associated with said derrick, said signal initiating an indication to the driller that it is safe to raise the elevator having been used to lower said first joint of casing, said signal being selected from the class consisting essentially of hydraulic signals, pneumatic signals, electrical signals, electronic signals, optical signals, microwave signals, infra-red signals, and combinations thereof.

2. The method according to claim 1, wherein said indication comprises one or more lights which are visible to the driller.

3. The method according to claim 1, wherein said indication is audible to the driller.

4. The method according to claim 3, wherein said indication comprises a siren.

5. The method according to claim 3, wherein said indication comprises a horn.

6. The method according to claim 1, wherein said indication comprises a tactile member.

7. The method according to claim 6, wherein said tactile member comprises a vibrator which can be felt by the driller.

8. The method according to claim 1 wherein said indication is visible to the driller at the driller's console.

9. The method according to claim 8, wherein said indication comprises a moveable member.

10. The method according to claim 9 wherein said moveable member comprises a flag.

11. A system for improving the communication between the driller and the stabber in a casing stabbing operation involving the stabbing of a first joint of casing into a second joint of casing, carried on within an oilfield derrick, comprising:
a transmitter at a first location within or near said derrick for transmitting a signal from the stabber to the driller at a second location at or near the rig floor associated with said derrick, said signal being indicative of the fact that it is safe to raise the elevator having been used to lower said first joint of casing into contact with said second joint of casing;
a receiver at a second location at or near the rig floor associated with said derrick, said receiver being used to initiate an indication to the driller that it is safe to raise the elevator.

12. The system according to claim 11, said transmitting signal being selected from the class consisting essentially of hydraulic signals, pneumatic signals, electrical signals, electronic signals, optical signals, microwave signals, infra-red signals, and combinations thereof.

13. The system according to claim 12, wherein said indication is selected from the class consisting essentially of visual indications, audible indications, tactile indications, and combinations thereof.
